(19) United States
(12) Patent Application Publication
(10) Pub. No.: US 2013/0151896 A1
(43) Pub. Date: Jun. 13, 2013

(54) INFORMATION PROCESSING APPARATUS AND TEST METHOD

(71) Applicant: FUJITSU LIMITED, Kawasaki-shi (JP)

(72) Inventor: Yoshikazu INAGAKI, Kawasaki (JP)

(21) Appl. No.: 13/662,658

(22) Filed: Oct. 29, 2012

(30) Foreign Application Priority Data
Dec. 8, 2011 (JP) 2011-269306

(51) Int. Cl. G06F 11/22

(52) U.S. Cl. 714/25; 714/E11.148

(57) ABSTRACT

Based on a seed value held by a managing apparatus for a plurality of information processing apparatuses, the same number of seed values as the total number of times of tests conducted by one or more processing units included in an information processing apparatus are generated so as not to overlap with another information processing apparatus. Then, a processing unit of the one or more processing units generates the same number of test instruction sequences as the number of times of tests performed by the processing unit based on the same number of seed values as the number of times of tests performed by the processing unit among the generated seed values, and executes the generated test instruction sequences.

### CROSS-REFERENCE TO RELATED APPLICATION

This application is based upon and claims the benefit of priority of the prior Japanese Patent Application No. 2011-269306, filed on Dec. 8, 2011, the entire contents of which are incorporated herein by reference.

### FIELD

The embodiments discussed herein relate to an information processing apparatus to generate and execute a test instruction sequence, a test method, and a recording medium.

### BACKGROUND

As a test method of an information processing system having a plurality of information processing apparatuses (computers) that respectively include one or more central processing unit (CPU), a method to make each information processing apparatus execute a test instruction sequence has been known.

In this test method, random data is generated with a seed value to be the initial value of random number generation as the input; a test instruction sequence is generated based on the random data; and each CPU of each information processing apparatus is made to execute the test instruction sequence. As the seed value, for example a value of K bytes (K is an integer being 1 or larger). Then, after the execution of the test instruction sequence is completed, the test is repeated by generating a test instruction sequence again using a random value generated newly based on random data or a value in which 1 is added to the seed value as a new seed value. Accordingly, the absence/presence of a failure may be checked based on the execution results of the multiple tests.

At this time, since it is possible to generate the same test instruction sequence constantly as long as the same seed value is used, by conducting the test again using the seed value that was used when a failure occurred, the failure may be reproduced easily. A technique has also been known in which, in a multi node system including a plurality of nodes respectively including one or more CPUs, by synchronizing nodes during the execution of the test instruction sequence, the reproducibility of the problem occurrence timing is secured.

In addition, a method has also been known in which, in a multiprocessor system, a processor managing unit sets an initial value for each processor, and each processor generates a random number so that the random numbers generated from those initial values become a series of random numbers.

Patent Document 1: Japanese Laid-open Patent Publication No. 11-53209

Patent Document 2: Japanese Laid-open Patent Publication No. 8-339294

### SUMMARY

According to an aspect of the embodiments, a test method includes (1) and (2) below.

(1) Generating, by a processing unit of one or more processing units included in an information processing apparatus among a plurality of information processing apparatuses, a fist number of test instruction sequences based on the first number of seed values among a second number of seed values generated based on a seed value held by a managing apparatus for the plurality of information processing apparatuses so as not to overlap with another information processing apparatus.

The fist number is same as a number of times of tests conducted by the processing unit and the second number is same as a total number of times of tests conducted by the one or more processing units.

(2) Executing the fist number of test instruction sequences by the processing unit.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a configuration diagram of an information processing system;

FIG. 2 is a flowchart of the first test;

FIG. 3 is a functional configuration diagram of a managing apparatus;

FIG. 4 is a functional configuration diagram of an information processing apparatus;

FIG. 5 is a flowchart of the second test;

FIG. 6 is a diagram (part 1) illustrating a seed value generation process;

FIG. 7 is a diagram (part 2) illustrating a seed value generation process;

FIG. 8 is a diagram (part 3) illustrating a seed value generation process;

FIG. 9 is a diagram (part 4) illustrating a seed value generation process;

FIG. 10 is a diagram (part 5) illustrating a seed value generation process;

FIG. 11 is a diagram (part 6) illustrating a seed value generation process;

FIG. 12 is a diagram (part 7) illustrating a seed value generation process;

FIG. 13 is a flowchart of the third test;

FIG. 14 is a flowchart of the first seed value generation process;

FIG. 15 is a flowchart of the second seed value generation process;

FIG. 16 is a diagram illustrating the first array;

FIG. 17 is a diagram illustrating the second array; and

FIG. 18 is a configuration diagram of an information processing apparatus.

### DESCRIPTION OF EMBODIMENTS

In the conventional test method of the information processing system described above, by repeating the generation of random data based on a seed value and the execution of a test instruction sequences generated based on the random data, the presence/absence of a failure may be checked based on the execution results of multiple tests. However, this test method has the following problems.

(1) In a test in the CPU design verification stage, from the viewpoint of logical verification, it is important to make the CPU execute more patterns of instruction sequences in the limited verification period, to check the normality. However, when tests by test instruction sequences are performed in a multi node system or a multiprocessor system, there is some waste in the test time since the respective CPUs execute the same test instruction sequence.

(2) In the verification stage of a plurality of information processing apparatuses such as the personal computer, the multi node system and the multiprocessor system, each verifier may make each information processing apparatus execute a similar test program. In this case, when each information processing apparatus executes a test instruction sequence without particularly specifying a seed value, the test instruction sequences executed by the CPUs become similar, halving the test completeness. Therefore, it is desirable to use a different seed value at each information apparatus, but when the number of information processing apparatuses and the number of verifiers become large, the work to assign the seed values in advance becomes troublesome.

(3) When using random data generated from a seed value in the next seed value generation, the next seed value is generated by a prescribed random number generation algorithm every time the test is conducted. For this reason, as the test is repeated, there is a possibility that a seed value that has already been used is generated again, and the same seed value is used repeatedly. In this case, the patterns of the instruction sequence do not increase after the point of time at which a seed value that has already been used is generated and the test completeness does not improve even if the test is conducted for a long period of time.

(4) In the verification stage of a plurality of information processing apparatuses, it is possible that a processor managing unit sets an initial value for each processor, each processor adopts a method to generate a random number, and a test instruction sequence is generated from the generated random number. In this case, while it is possible to generate a series of random numbers between processors in a multiprocessor system, there is a possibility that the same random number as the random number generated in another information processing apparatus is generated. In addition, in a multiprocessor system, after the system reset or when the execution of the program is terminated and the system is started up again, since the random number is generated by the same algorithm, there is a high possibility that the same random number as used before is generated. Thus, it is hard to avoid the overlapping of the random numbers that are the basis of the test instruction sequences, making it difficult to improve the test completeness.

Meanwhile, such a problem arises not only when random data is generated based on a seed value and the test instruction sequence is generated based on the random data, but also when the test instruction sequence is generated based a seed value.

Hereinafter, an embodiment is described in detail with reference to drawings.

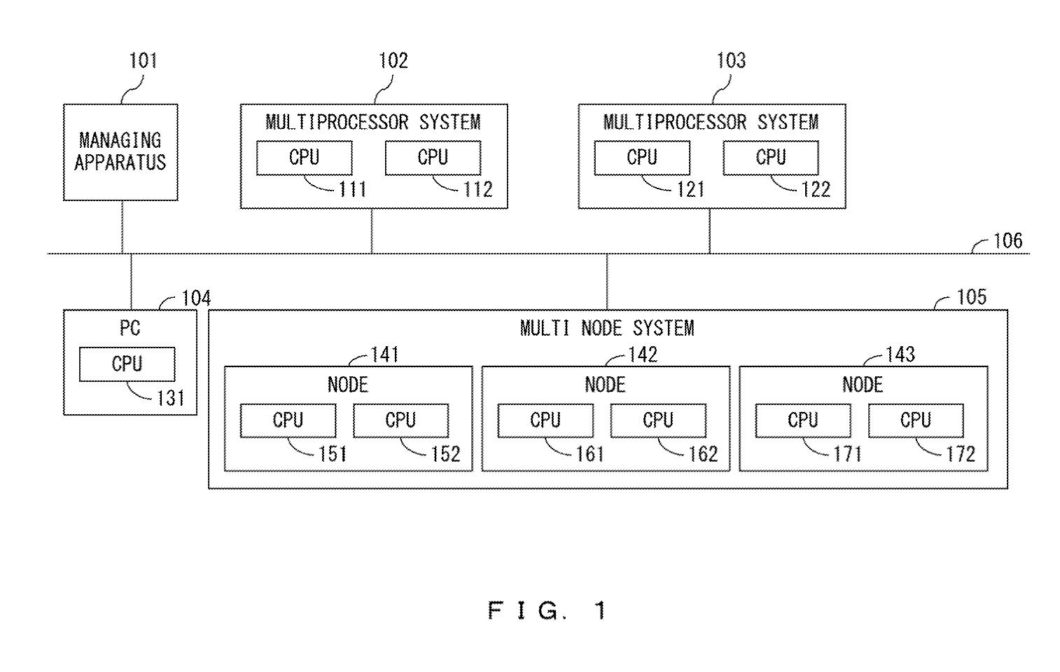

FIG. 1 illustrates a configuration example of an information processing system including a plurality of information processing apparatuses. The information processing system in FIG. 1 includes a managing apparatus 101, multiprocessor systems 102, 103, a personal computer (PC) 104, and a multi node system 105. The multiprocessor system 102, 103, PC104, and the multi node system 105 are connected to each other by a communication network 106.

The multiprocessor system 102 is an information processing apparatus that includes CPUs 111 and 112, and the multiprocessor system 103 is an information processing apparatus that includes CPUs 121 and 122. The PC 104 is an information processing apparatus that includes a CPU 131, and the multi node system 105 is an information processing apparatus that includes nodes 141, 142, and 143. The node 141 includes CPUs 151 and 152, the node 142 includes CPUs 161 and 162, and the node 143 includes CPUs 171 and 172. The managing apparatus 101 is an information processing apparatus that holds the seed value for these information processing apparatuses.

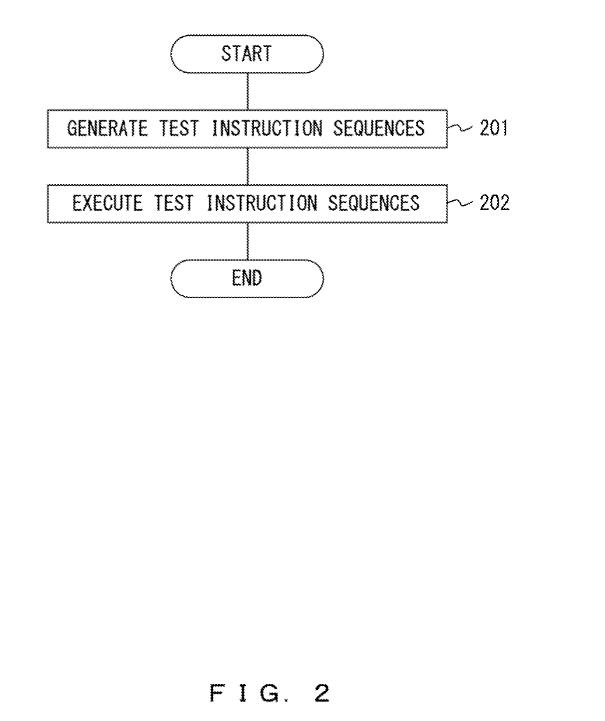

FIG. 2 is a flowchart illustrating an example of a test conducted by each information processing apparatus in FIG. 1 performs. First, a certain CPU in one or more CPUs included in the information processing apparatus generates, based on the same number of the seed value as the number of times of tests conducted by the CPU among the same number of the seed values as the total number of times of tests conducted by the one or more CPUs, the same number of the test instruction sequences as the number of times of tests conducted by the CPU (step S201).

The same number of seed values as the total number of times of tests are seed values generated so as not overlap with other information processing apparatuses, based on the seed value that the managing apparatus 101 holds. Next, the CPU executes the generated test instruction sequences (step S202).

By providing the managing apparatus 101 that holds the seed value for a plurality of information processing apparatuses on the communication network 106 accessible from each information processing apparatus, each information processing apparatus is able to use seed values that do not overlap with other information processing apparatuses, in generating the test instruction sequences. Furthermore, by generating the same number of the seed values as the total number of times of tests conducted by all the CPUs included in each information processing apparatus so as not to overlap with other information processing apparatuses, generation of the same test instruction sequence between any two CPUs of all the information processing apparatuses is prevented. Therefore, the test completeness in the entire information processing system may be improved.

While four information processing apparatuses are included besides the managing apparatus 101 in the information processing system in FIG. 1, the number of the information processing apparatuses may be 3 or less, or may be 5 or more. In addition, the type of the information processing apparatus is not limited to the multiprocessor system, PC and multi node system, and another type of information processing apparatus including one or more CPUs may be used. The number of CPUs included in each information processing apparatus or each node is not limited to 1 or 2, and may be 3 or more.

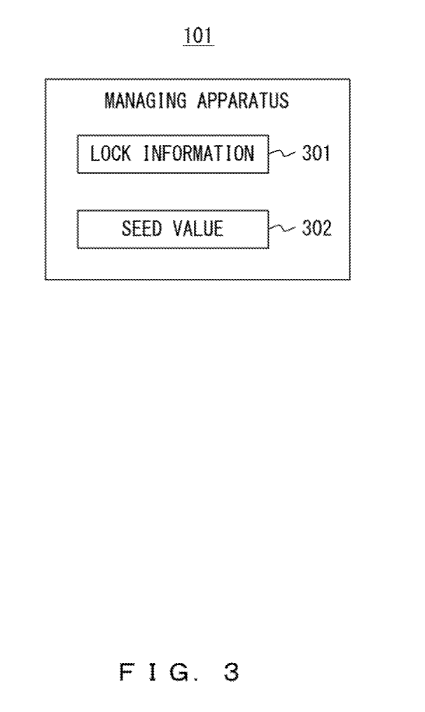

FIG. 3 illustrates an example of information held by the managing apparatus 101 in FIG. 1. The managing apparatus 101 in FIG. 3 holds lock information 301 and a seed value 302. The seed value 302 is a seed value that has already been assigned to one of the information processing apparatuses, and the lock information 301 is information for exclusive control indicating the permission/denial of access to the seed value 302. The lock information 301 indicates one of the unlock state representing the access permission or the lock state representing the access denial.

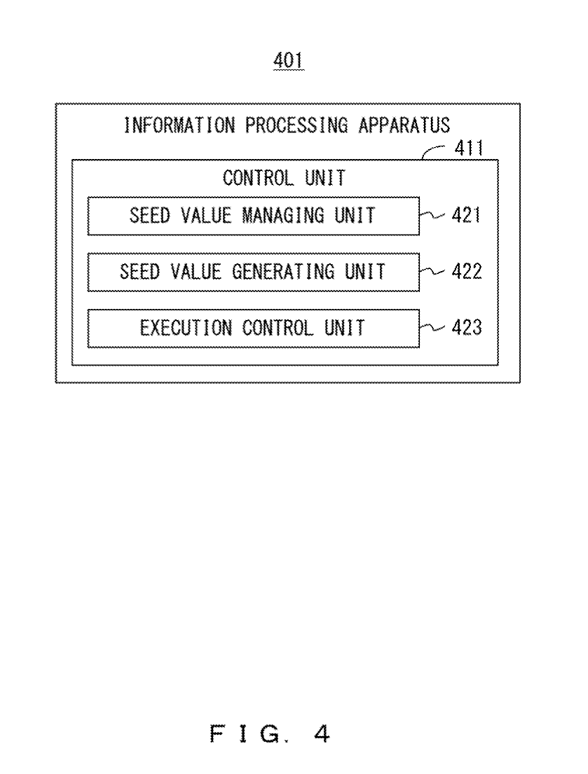

FIG. 4 illustrates a functional configuration example of each information processing apparatus in FIG. 1, an information processing apparatus 401 in FIG. 4 includes a control unit 411, and the control unit 411 includes a seed value managing unit 421, a seed value generating unit 422 and an execution control unit 423. Meanwhile, the control unit 411 is also referred to as a processing unit.

The seed value managing unit 421 calculates the total number of times of tests conducted by all the CPUs included in the information processing apparatus 401, and the seed value generating unit 422 obtains the seed value 302 from the managing apparatus 101 and generates the same number of the seed values as the total number of times of tests. The execution control unit 423 distributes the generated seed values to each CPU.

The process in the control unit 411 is performed by one of the CPUs in the information processing apparatus 401 for example. Therefore, it is also possible to provide a plurality of control units 411 in the information processing apparatus 401. For example, in the multiprocessor system 102 in FIG. 1, the control unit 411 may be provided either one of the CPU 111 or the CPU 112, and in the multiprocessor system 103, the control unit 411 may be provided in each of the CPU 121 and the CPU 122.

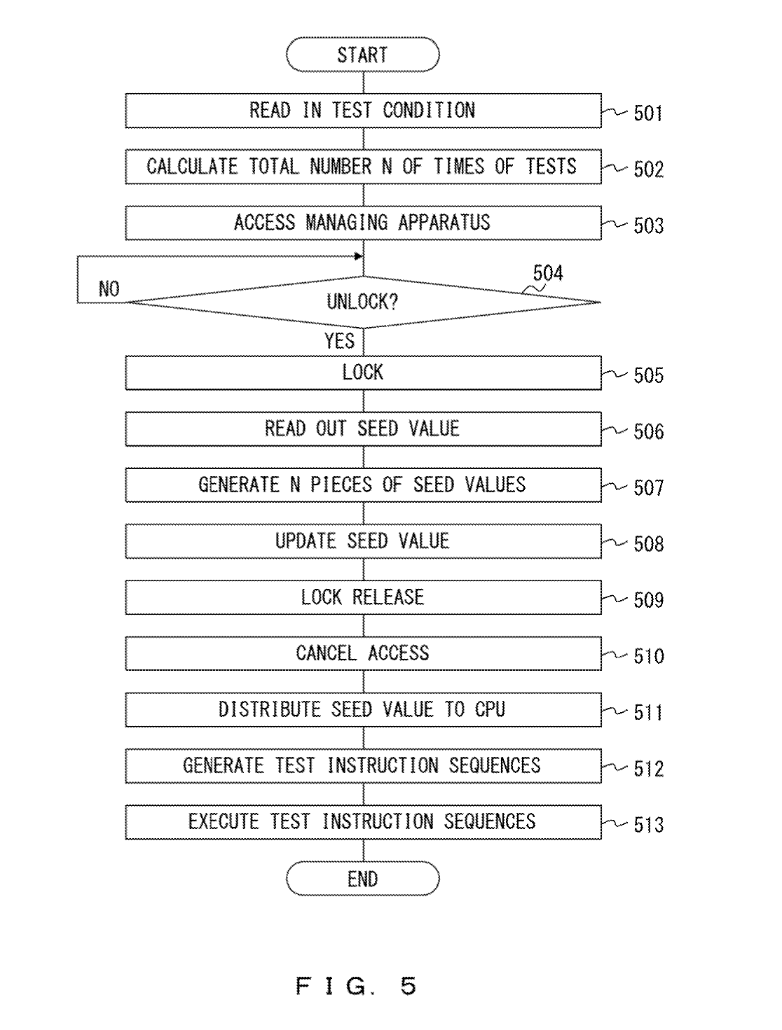

FIG. 5 is a flowchart illustrating an example of the test conducted by the information processing apparatus 401. The seed value managing unit 421 reads in the test condition specified by the operator (step S501), and based on the test condition, calculates the total number N of times of tests conducted by all the CPUs included in the information processing apparatus 401 (step 502).

As the test condition, for example, the number of times of tests for each CPU in the information processing apparatus 401, the total test time for the information processing apparatus 401, and the like, is specified. When the number of times of tests for each CPU is specified, the total number N is obtained by adding those numbers for the CPUs. Meanwhile, when the total test time is specified, the total test time is divided by the test time per one time of test to obtain the number of times of tests, and the total number N is obtained by multiplying the obtained number of times of tests by the number of CPUs that execute the test instruction sequences. The test time per one time of test and the number of CPUs that execute the test instruction sequences are specified in advance as a parameter.

Next, the seed value generating unit 422 performs a remote access to the managing apparatus 101 via the communication network 106 (step 503), and checks the lock information 301 (step 504). When the lock information indicates the lock state (step 504, NO), it waits until the lock information becomes the unlock state. On the other hand, when the lock information 301 indicates the unlock state (step 504, YES), it sets the lock information 301 to the lock state, and obtains the exclusive access right (step 505).

Next, the seed value generation unit 422 reads out the seed value 302 from the managing apparatus 101, and generates N pieces of seed values based on the seed value 302 (step 507). In step 506, the seed value generating unit 422 transmits a seed value request to the managing apparatus 101, and receives the seed value 302 from the managing apparatus 101. In step 507, for example, when the seed value 302 is M, N pieces of seed values from M to M+N−1 are generated by incrementing M by 1.

Next, the seed value generating unit 422 updates the seed value 302 by overwriting the seed value 302 with the value M+N in which N is added to M (step 508). Then, it releases the exclusive access right by setting the lock information 301 to the unlock state (step 509), and cancels the access to the managing apparatus 101 (step 510).

Next, the execution control unit 423 distributes, among the generated N pieces of seed values, the same number of the seed values as the number of times of tests conducted by each CPU to the CPU, and instructs each CPU to start the test (step 511). At this time, a different seed value is distributed to each CPU so that the seed values do not overlap between the CPUs.

Next, each CPU generates, using the distributed one or more seed values, the same number of the test instruction sequences as the number of the seed values (step 512), and executes those test instruction sequences (step 513). When the number of the distributed seed values is S, S pieces of different test instruction sequences are generated. The processes in step 512 and 513 are performed in parallel between the CPUs.

In step 512, random data is generated from each seed value based on a random number generation algorithm, and a test instruction sequence is generated using the random data. For example, using AND data and OR data prepared for each instruction, an instruction may be generated by obtaining a logical product of the random data and the AND data, and obtaining a logical sum of the logical product and the OR data. As the random number generation algorithm, Mersenne Twister, the middle-square method, the linear congruent method, and the like may be used.

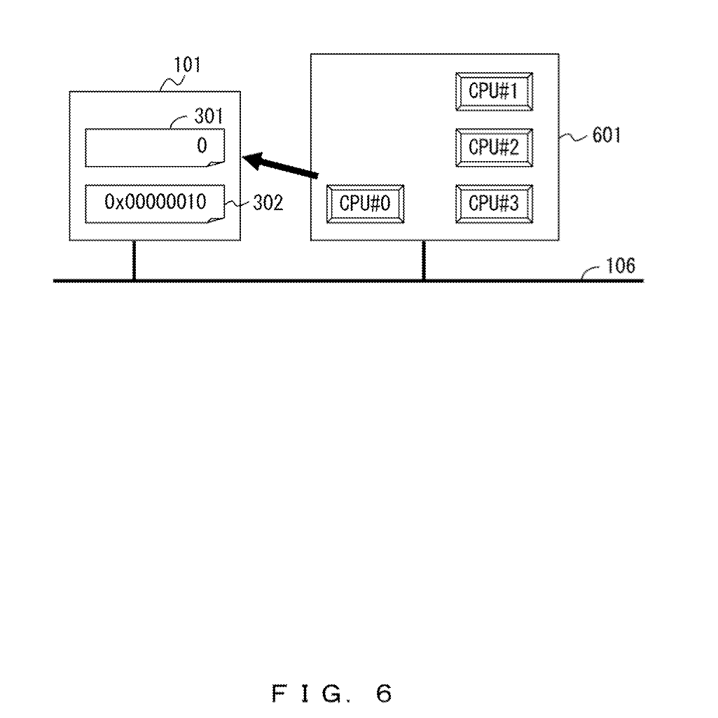

Next, with reference to FIG. 6 through FIG. 12, a specific example of the seed value generation process is explained. In this specific example, it is assumed that the number of times of tests conducted by each CPU is 1, and the total number N of times of tests corresponds to the number of CPUs included in each information processing apparatus.

FIG. 6 is a configuration in which another information processing apparatus is connected to the communication network 106 in the information processing system in FIG. 1. A multiprocessor system 601 in FIG. 6 includes four CPUs CPU#0-CPU#3. The lock information 301 of the managing apparatus 101 indicates the lock state when its value is “1”, and indicates the unlock state when it is “0”.

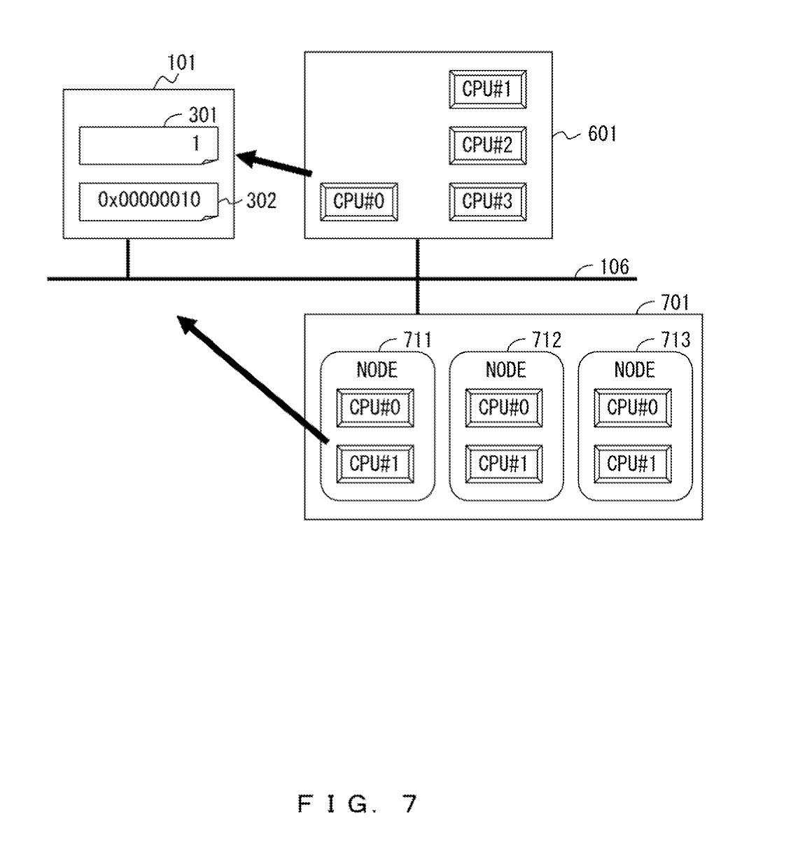

The multiprocessor system 601 first accesses the managing apparatus 101 and checks the lock information 301. There, since the value of the lock information 301 is “0”, as illustrated in FIG. 7, “1” is written into the lock information 301 to set the lock state.

Next, a multi node system 701 connected to the communication network 106 accesses the managing apparatus 101 and checks the lock information 301. At this time, since the value of the lock information 301 is “1”, it waits until the state becomes the unlock state . The multi node system 701 includes nodes 711, 712, and 713, and each node includes CPU#0 and CPU#1.

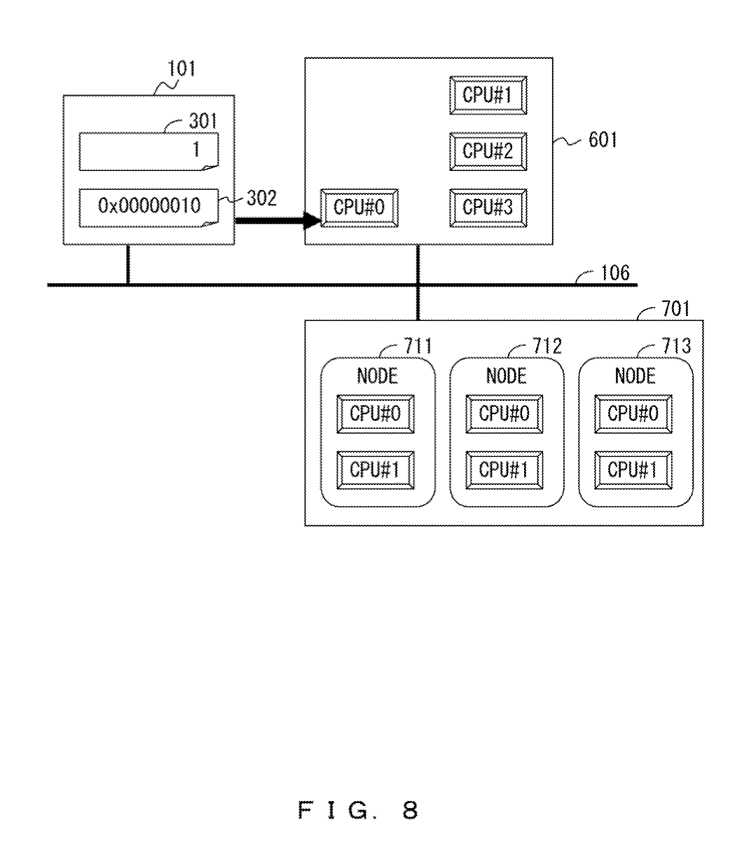

Next, as illustrated in FIG. 8, the multiprocessor system 601 reads out the seed value 302 from the managing apparatus 101, and generates four pieces of seed values based on the seed value 302. Here, since the seed value 302 is “0x00000010” (hexadecimal number), four pieces of seed values “0x00000010”-“0x00000013” are generated.

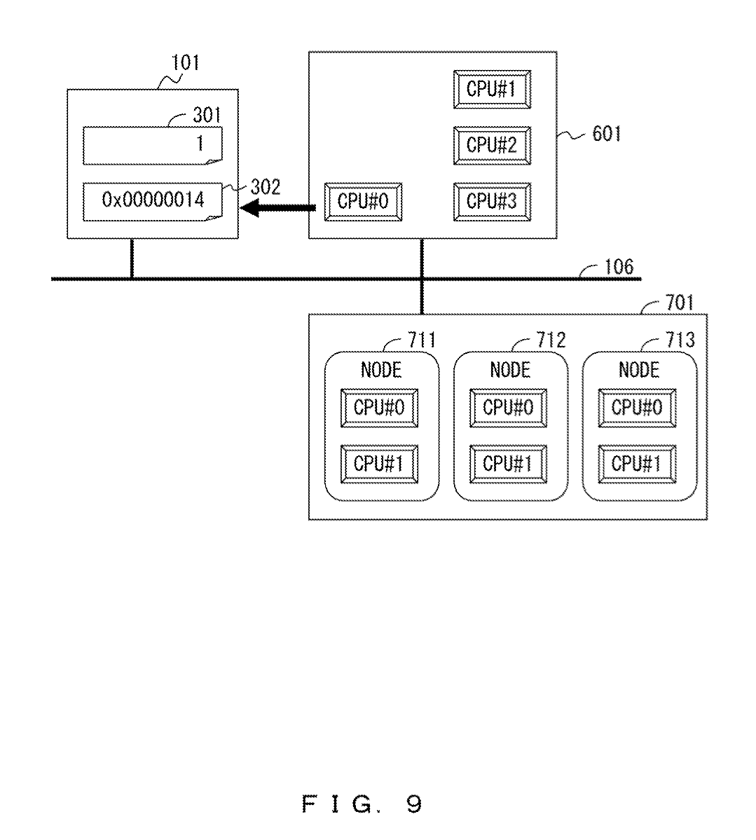

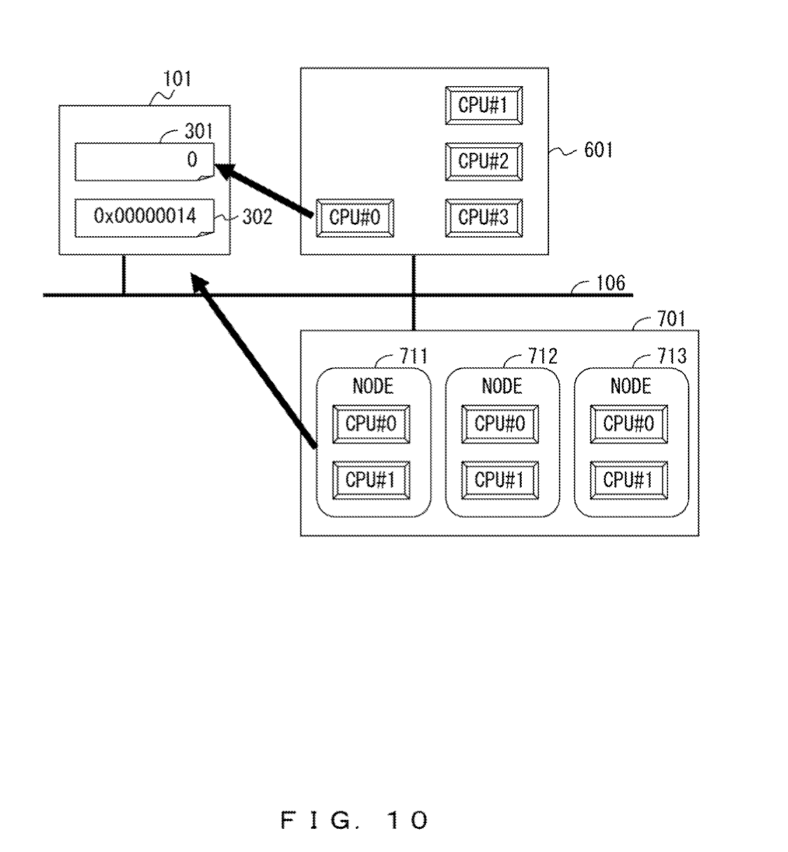

Next, as illustrated in FIG. 9, the multiprocessor system 601 updates the seed value 302 by overwriting the seed value 302 of the managing apparatus 101 with the value “0x00000014” in which 4 is added to “0x00000010”. Then, it writes “0” into the lock information 301 to set it to the unlock state as illustrated in FIG. 10.

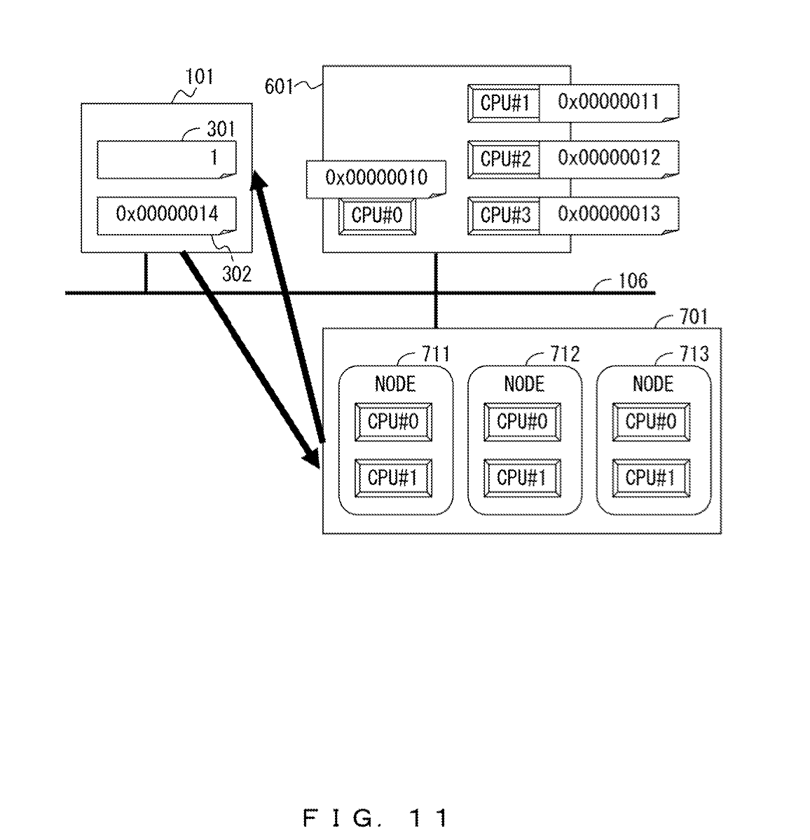

After that, the multi node system 701 that has been waiting writes “1” in the lock information 301 to set it to the lock state as illustrated in FIG. 11, reads out the seed value 302 from the managing apparatus 101 and generates six pieces of seed values. Here, since the seed value 302 is “0x00000014”, six pieces of seed values “0x00000014”-“0x00000019” are generated.

Meanwhile, the multiprocessor system 601 distributes the generated four pieces of seed values to each CPU, and each CPU generates a test instruction sequence using the distributed seed value, and executes the test instruction sequence.

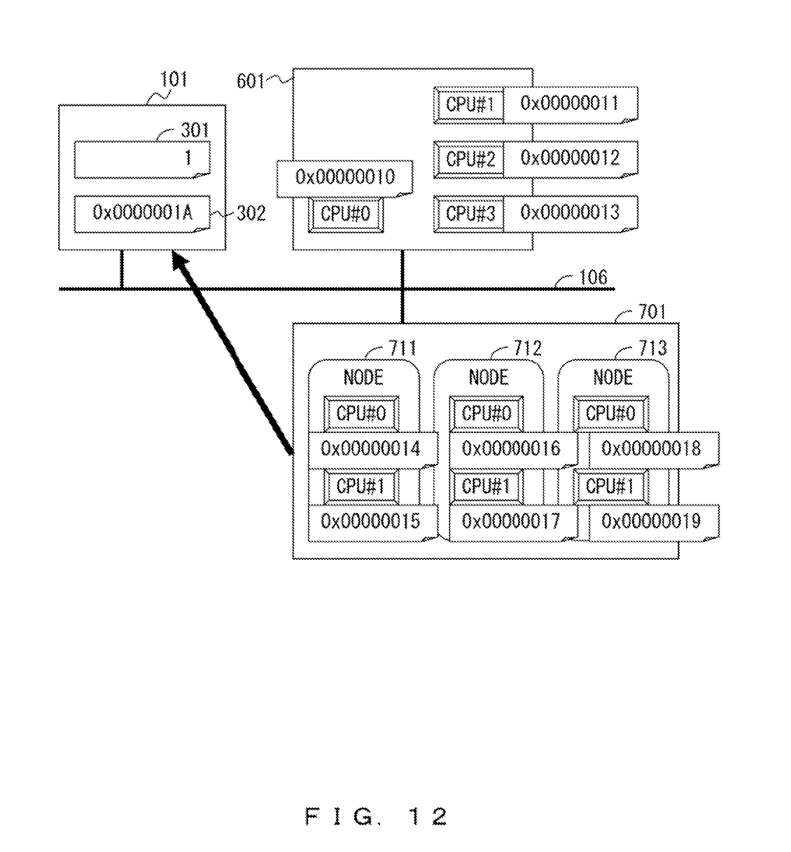

Next, as illustrated in FIG. 12, the multi node system 701 updates the seed value 302 by overwriting the seed value 302 of the managing apparatus 101 with the value “0x0000001A” in which 6 is added to “0x00000014”. Then, it writes “0” into the lock information 301, and distributes the generated six seed values to each CPU. Each CPU generates a test instruction sequence using the distributed seed value, and executes the test instruction sequence.

While the information processing apparatus 401 generates N pieces of seed values based on the seed value 302 obtained from the managing apparatus 101 in the test in FIG. 5, the managing apparatus 101 may generate the seed values and transmit them to the information processing apparatus 401.

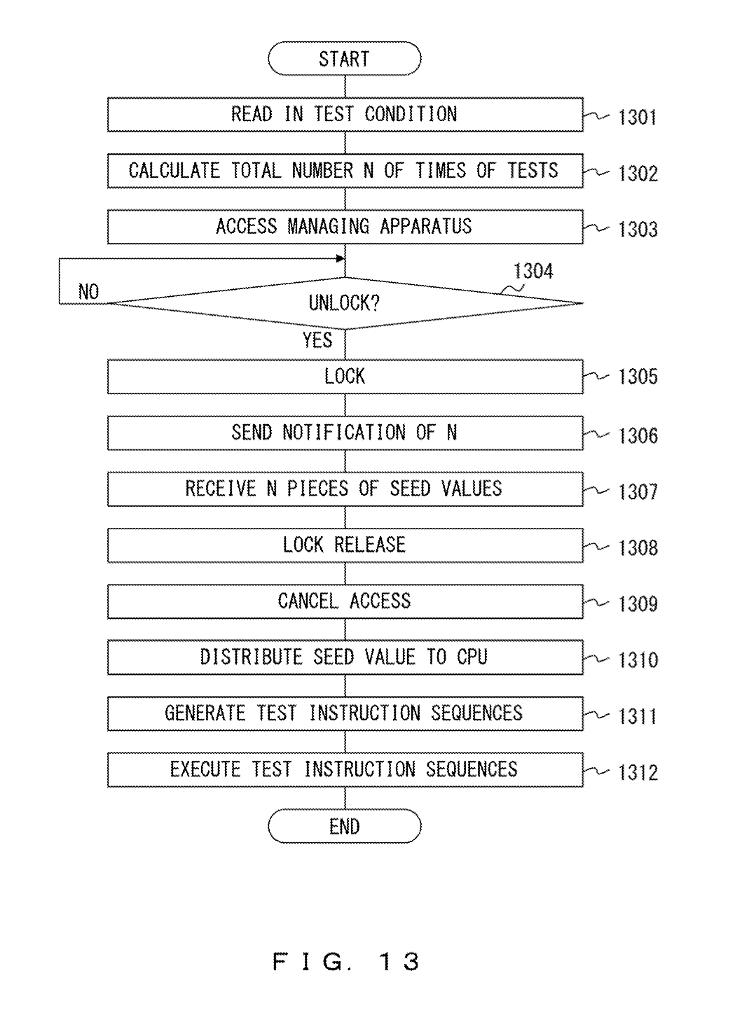

FIG. 13 is a flowchart illustrating an example of such a test. The processes in steps 1301-1305 and 1308-1312 are similar to the processes in steps 501-505 and 509-513.

The seed value generating unit 422 of the information processing apparatus 401 sets the lock information 301 to the lock state in step 505, and after that, sends a notification of the total number N of times of tests to the managing apparatus 101 (step 1306).

The managing apparatus 101 generates and transmits to the information processing apparatus 401, N pieces of seed values based on the seed value 302. When the seed value 302 is M, N pieces of seed values from M to M+N−1 are generated by incrementing M by 1 for example. Then, the managing apparatus 101 updates the seed value 302 by overwriting the seed value 302 with the value M+N in which N is added to M.

The seed value generating unit 422 of the information processing apparatus 401 receives N pieces of seed values from the managing apparatus 101 (step 1307), and performs processes in and after step 1308.

According to the information processing system described above, since the managing apparatus 101 generates the seed values and distributes them to the information processing apparatus 401, there is no longer a need to implement a seed value generation algorithm in each information processing apparatus 401.

Incidentally, as the seed value generation method in the managing apparatus 101, various methods other than the method to increment M by 1 are possible. For example, N pieces seed values may be generated using an integer Y being 2 or larger and incrementing M by Y.

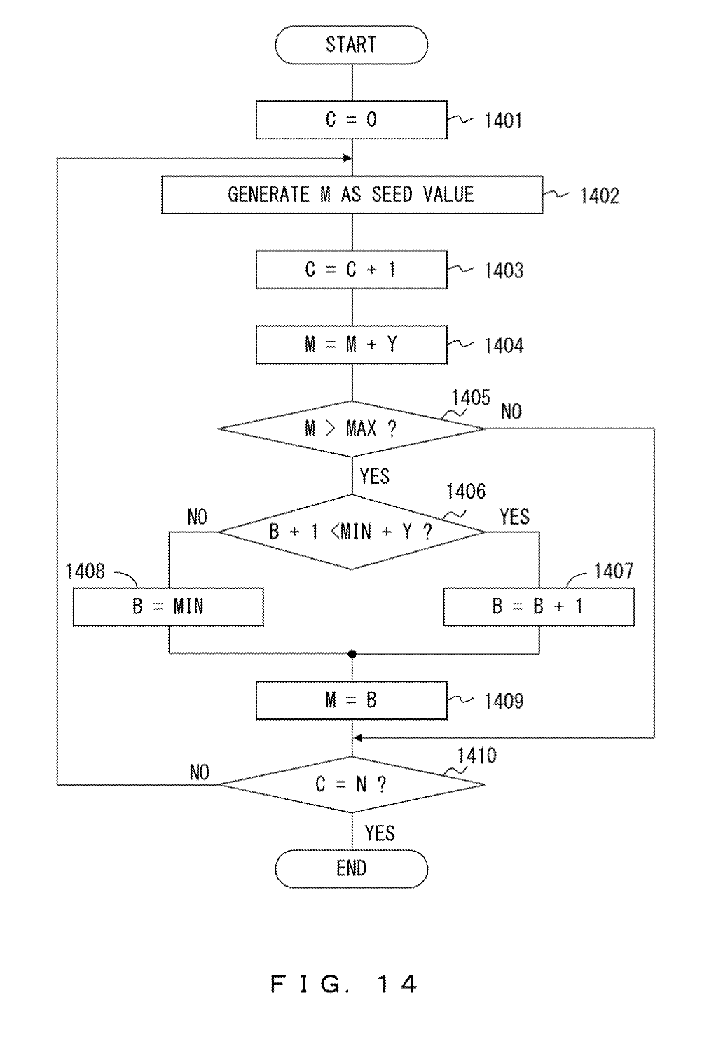

FIG. 14 is a flowchart illustrating an example of such a seed value generation process. The range of the values that the seed value M may take is from the minimum value MIN to the maximum value MAX, and the initial value of M is MIN. The managing apparatus 101 holds a basic seed value B besides M. The range of values that B may take is from MIN to MIN+Y−1, and the initial value of B is MIN.

First, the managing apparatus 101 sets a variable C indicating the number of seed values that have already been generated to 0 (step 1401), and generates M as the seed value (step 1402). Next, C is incremented by 1 (step 1403), M is incremented by Y (step 1404), and M is compared with MAX (step 1405).

When M is equal to or smaller than MAX, (step 1405, NO), C is compared with N (step 1410). Then, when C has not reached N, (step 1410, NO), the processes in and after step 1402 are repeated.

On the other hand, when M has exceeded MAX (step 1405, YES), B+1 and MIN+Y are compared (step 1406). When B+1 has not reached MIN+Y (step 1406, YES), B is incremented by 1 (step 1407). Then, M=B is set (step 1409), and the processes in and after step 1410 are performed. On the other hand, when B+1 has reached MIN+Y (step 1406, NO), B=MIN is set (step 1408), and processes in and after step 1409 are performed.

Thus, until M exceeds MAX, the seed value is generated sequentially from MIN in an increment of Y, and when M exceeds MAX, the seed value is generated sequentially from MIN+1 in an increment of Y. Then, every time M exceeds MAX, the initial value B of M is incremented, and when B+1 reaches MIN+Y, B is set to the initial value MIN again. Therefore, when M does not exceed MAX, N pieces of seed values M, M+Y, M+2Y, M+3Y, M+(N−1) Y are generated and the seed value 302 becomes M+NY.

The managing apparatus 101 may also generate N pieces of seed values based on the current time. In this case, current time T is used as the seed value 302.

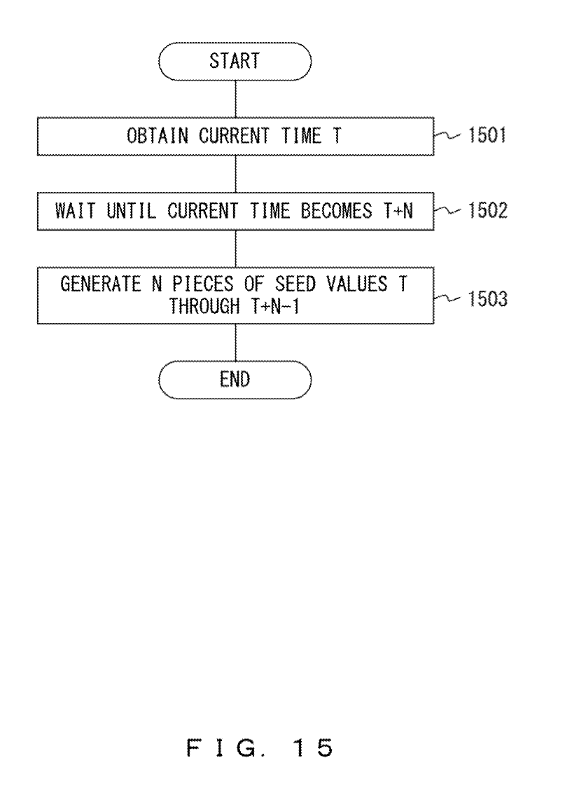

FIG. 15 is a flowchart illustrating an example of such a seed value generation process. First, the managing apparatus 101 obtains information of the current time T from inside or outside the apparatus (step 1501), and waits until the current time becomes T+N (step 1502). Then, when the current time becomes T+N, N pieces of seed values from T to T+N−1 are generated by increasing T in increments of 1 (step 1503).

By sending the seed value to the information processing apparatus 401 after waiting until the current time becomes T+N, the overlap with a seed value that is transmitted to another information processing apparatus is prevented.

The current time T is a value obtained from the system time, system clock and the like of the managing apparatus 101, and as its minimum unit, minute, second, millisecond, microsecond, one clock of the Central Processing Unit (CPU) may be used. The waiting time in step 1502 is set based on the minimum unit. As the current time T, for example, the following values may be used.

(a) Coordinated Universal Time (UTC): The time that has elapsed since 00:00:00 on 1 Jan. 1970 in the minimum unit.

(b) The value of the time stamp counter in a prescribed number of bits that is increased every CPU clock.

(c) The value of TICK register of the CPU.

In addition, the managing apparatus 101 is also able to generate N pieces of seed values by shuffling an array of seed values. In this case, the managing apparatus 101 shuffles the array in which a prescribed range (the minimum value MIN-the maximum value MAX) of values are stored, and uses N pieces of values in order from the beginning of the array after the shuffle as seed values.

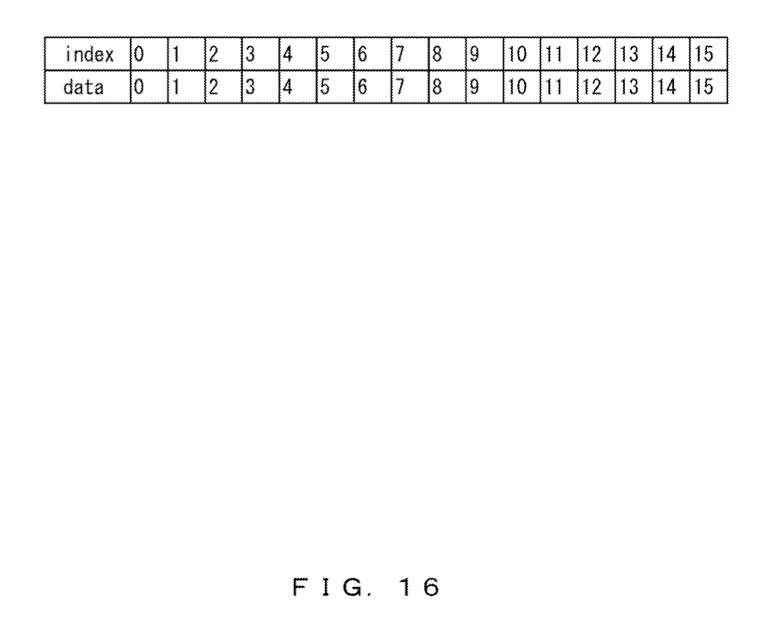

For example, when MIN=0, MAX=15, as illustrated in FIG. 16, an array storing data 0-15 that become the candidates of the seed values corresponding to index 0-15 that represent the data positions is generated. Then, N pieces of seed values are generated in the following procedure.

(1) Based on a random number generation algorithm, two random values included in the range of MIN-MAX are generated.

(2) Two pieces of data having the generated two random numbers as indexes are exchanged.

(3) The processes of (1) and (2) are repeated for prescribed times.

(4) N pieces of data in order from the beginning of the array are selected as the seed values.

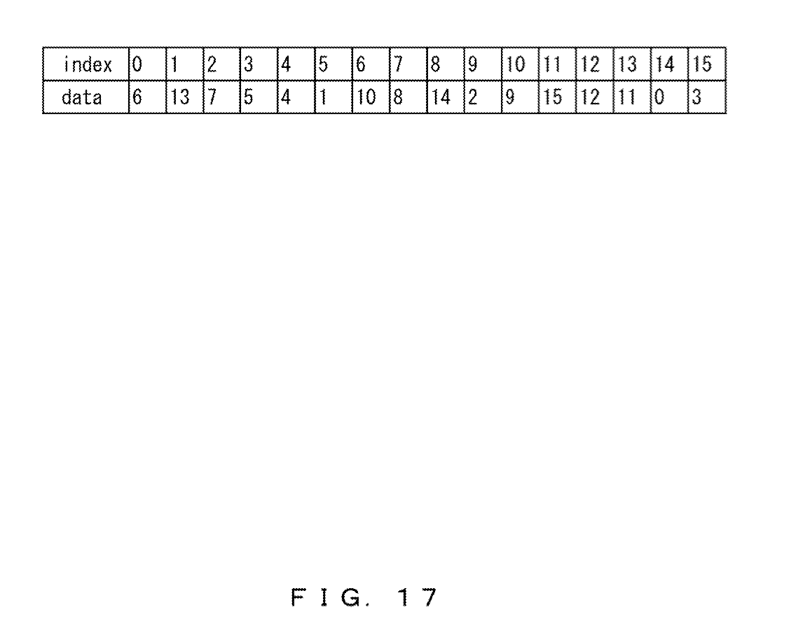

For example, when N=4, in order from the beginning of the array after shuffle as illustrated in FIG. 17, four pieces of data “6”, “13”, “7” and “5” are selected as the seed values.

According to the embodiment described above, by managing the seed value for a plurality of information processing apparatuses, generation of the same test instruction sequence between any two CPUs of all the information processing apparatuses is prevented. Therefore, the test completeness in the entire information processing system may be improved.

For this reason, it becomes possible to check the presence/absence of a failure by executing as many test instruction sequences as possible in the limited test time, and there is no longer a need for the operator to set the seed value to be used for each information processing apparatus for improving randomness. Furthermore, the overlap of the seed values due to the test executed for a long time or multiple times is prevented, and the plateauing of the test completeness is avoided.

In the flowchart in FIG. 5, it is not necessary to execute all the steps, and a part of the steps may be omitted or changed according to the configuration and condition of the information processing system. For example, when the total number N of times of tests is determined in advance, the processes in step 501 and 502 may be omitted. In addition, the seed value generation process in step 507 may be shifted after step 508, 509, or 510. In the flowcharts in FIG. 13-FIG. 15, in the same manner, a part of the steps may be omitted or changed according to the configuration and condition of the information processing system.

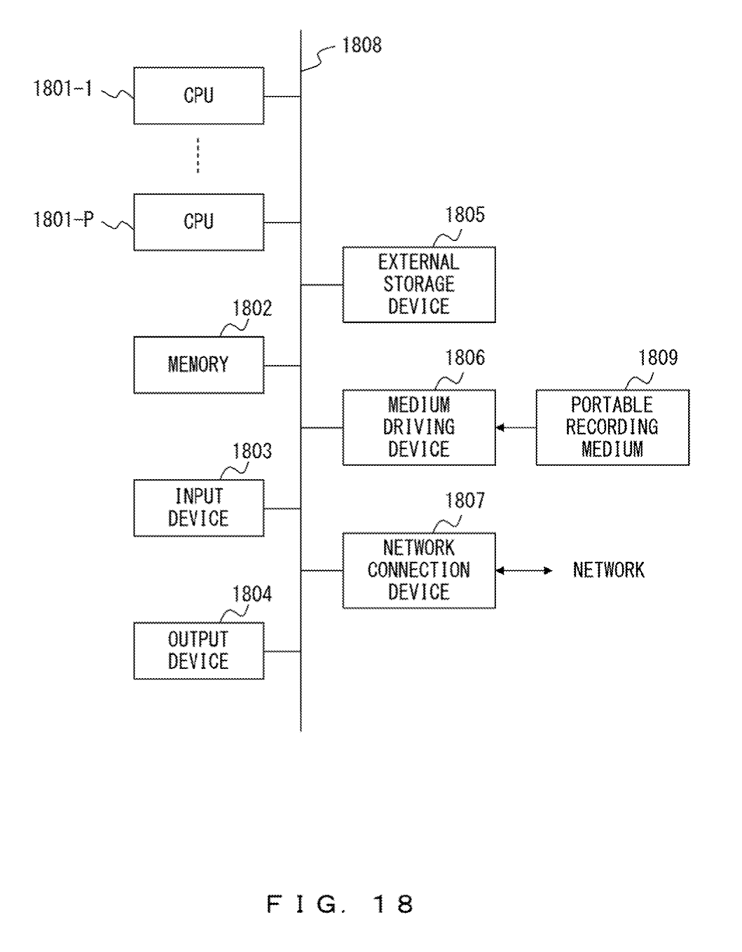

The information processing apparatus 401 in FIG. 4 maybe realized using the configuration illustrated in FIG. 18, for example. An information processing apparatus in FIG. 18 includes P units (P is an integer being 1 or larger) of CPUs 1801-1 through 1801-P, a memory 1802, an input device 1803, an output device 1804, an external storage device 1805, a medium driving device 1806, and a network connection device 1807. These are connected to each other by a bus 1808.

The memory 1802 is, for example, a semiconductor memory such as a Read Only Memory(ROM), a Random Access Memory(RAM), a flash memory and the like, which stores a program and data used for the process. For example, the CPU 1801 performs the processing of the control unit 411 by executing a program using the memory 1802.

The input device 1803 is, for example, a keyboard, a pointing device and the like, which is used for the input of an instruction and information from the user or the operator. The output device 1804 is, for example, a display device, a printer, a speaker, and the like, which is used for the output of the inquiry to the user or the operator or the processing result.

The external storage device 1805 is, for example, a magnetic disc device, an optical disc device, a magneto-optical disc device, a tape device, and the like. A hard disc drive is also included in the external storage device 1805. The information processing apparatus may store a program and data in the external storage device 1805, and may load them onto the memory 1802 to use them.

The medium driving device 1806 drives a portable recording medium 1809, and accesses its recorded contents. The portable recording medium 1809 is a memory device, a flexible disc, an optical disc, a magneto-optical disc and the like. The Compact Disk Read Only Memory (CD-ROM), the Digital Versatile Disk (DVD), the Universal Serial Bus (USB)memory and the like are also included in the portable recording medium 1809. The user or the operator may store a program and data in the portable recording medium 1809, and may load them onto the memory 1802 to use them.

Thus, a physical (non-transitory) recording medium such as the memory 1802, the external storage device 1805 and the portable recording medium 1809 are included in the computer-readable recording medium that stores the program and data used for various processes.

The network connection device 1807 is a communication interface that is connected to the communication network 106 and performs data conversion associated with the communication. The information processing apparatus may receive the program and data from an apparatus outside via the network connection device 1807, and may load them onto the memory 1802 to use them.

Meanwhile, it is not necessary that each information processing apparatus includes all the constituent elements in FIG. 18, and a part of the constituent elements may be omitted or changed according to the purpose and condition. For example, when no interface with the user or the operator is needed, the input device 1803 and the output device 1804 may be omitted.

The managing apparatus 101 in FIG. 3 may also be realized using a similar configuration as in FIG. 18. In this case, the number of the CPU 1801 may be 1. The lock information 301 and the seed value 302 in FIG. 3 are held in the memory 1802 for example, and the CPU 1801 performs the processing of the managing apparatus 101 by executing the program using the memory 1802.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A test method comprising:
generating, by a processing unit of one or more processing units included in an information processing apparatus among a plurality of information processing apparatuses, a fist number of test instruction sequences based on the first number of seed values among a second number of seed values generated based on a seed value held by a managing apparatus for the plurality of information processing apparatuses so as not to overlap with another information processing apparatus, the fist number being same as a number of times of tests conducted by the processing unit and the second number being same as a total number of times of tests conducted by the one or more processing units; and
executing the fist number of test instruction sequences by the processing unit.

2. The test method according to claim 1, further comprising:
receiving the seed value held by the managing apparatus from the managing apparatus by the processing unit;
generating the second number of seed values based on the received seed value by the processing unit; and
updating the seed value held by the managing apparatus with a seed value different from the received seed value by the processing unit.

3. The test method according to claim 1, further comprising:
checking lock information held by the managing apparatus for exclusive control between the plurality of information processing apparatuses by the processing unit;
changing the lock information to a lock state by the processing unit when the lock information indicates an unlock state;
receiving the seed value held by the managing apparatus from the managing apparatus by the processing unit;
generating the second number of seed values based on the received seed value by the processing unit;
updating the seed value held by the managing apparatus with a seed value different from the received seed value by the processing unit; and
returning the lock information to the unlock state by the processing unit.

4. The test method according to claim 1, further comprising:
sending a notification of the second number of times of tests to the managing apparatus by the processing unit; and
receiving the second number of seed values from the managing apparatus by the processing unit.

5. The test method according to claim 1, further comprising:
checking lock information held by the managing apparatus for exclusive control between the plurality of information processing apparatuses by the processing unit;
changing the lock information to a lock state by the processing unit when the lock information indicates an unlock state;
sending a notification of the second number of times of tests to the managing apparatus by the processing unit;
receiving the second number of seed values from the managing apparatus by the processing unit; and
returning the lock information to the unlock state by the processing unit.

6. An information processing apparatus including one or more processing units, wherein
a processing unit of the one or more processing units generates a fist number of test instruction sequences based on the fist number of seed values among a second number of seed values generated based on a seed value held by a managing apparatus for a plurality of information processing apparatuses including the information processing apparatus so as not to overlap with another information processing apparatus, the fist number being same as a number of times of tests conducted by the processing unit and the second number being same as a total number of times of tests conducted by the one or more processing units, and executes the fist number of test instruction sequences.

7. A computer-readable recording medium having stored therein a program for causing a processing unit of one or more processing units included in an information processing apparatus to execute a process comprising:
generating a fist number of test instruction sequences based on the first number of seed values among a second number of seed values generated based on a seed value held by a managing apparatus for a plurality of information processing apparatuses including the information processing apparatus so as not to overlap with another information processing apparatus, the fist number being same as a number of times of tests conducted by the processing unit and the second number being same as a total number of times of tests conducted by the one or more processing units; and
executing the fist number of test instruction sequences.
